(19) United States
(12) Patent Application Publication
(10) Pub. No.: US 2007/0279687 A1
(43) Pub. Date: Dec. 6, 2007

(54) Information providing system and information providing method

(75) Inventor: Hirohisa Naito, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/889,331

(22) Filed: Aug. 10, 2007

Related U.S. Application Data
(63) Continuation of application No. PCT/JP2005/002081, filed on Feb. 10, 2005.

(51) Int. Cl. G06F 3/12

(52) U.S. Cl. 358/1.15

(57) ABSTRACT

An information providing system determines an instantaneous group formed by users that are hanging together at a given time, and provides information to the users of the instantaneous group customized to the instantaneous group. For example, one user may be a part of an instantaneous group A at one given time and the same user may be a part of an instantaneous group B at another given time.

### BACKGROUND OF THE INVENTION

1. Field of the Invention

The present invention relates to an information providing system and an information providing method that provide information personalized according to groups.

2. Description of the Related Art

Information of various kinds is flooding the world through various means, be it through media such as television, radio, e-mail, and the Web, parallel with development in multimedia technology, or through conventional means such as handbills, posters, billboards, bulletin boards. Users sift through the information they come across and choose what best suits their activities.

However, the very overabundance of information makes it difficult for the user to easily select information useful to himself/herself. Therefore, to enable the user to obtain information that the user can actually use, information providing systems are being developed that provide information personalized to every user.

For example, there are available recommender systems that recommend information to individuals (personalizing information to suit the individual). Such recommender systems operate based on content-based filtering and collaborative filtering. In content-based filtering, information is filtered based on the individual's preferences and in collaborative filtering information is filtered by referring to one's own history and the histories of others, and attributes of objects and eliminating information concerning objects one is not interested in.

Such recommender systems developed for individuals do not necessarily prove to be useful in the selection of activities made by people in actuality. In reality, an individual's selection of activity, apart from being based on his/her own individual self, is also influenced by who the individual is with at a given time. In other words, an individual's selection of activity at any given time will vary depending on whether a friend or a colleague, or a family member is with him/her. For example, in spite of one's personal preference for action movies, an individual may prefer to watch a romantic movie when in the company of a sweetheart and a children's movie when a child is accompanying the individual. Thus, an individual's selection of activity is largely influenced by the company the individual is with rather than by his/her own profile and interests.

This has given rise to a technology for providing predetermined information targeted at predetermined groups. For example, an information providing system is available that provides information according to the location of a group comprising a plurality of users.

In a condition detecting system described in, for example, Japanese Patent Application Laid-open No. 2004-7496, locations of each of a plurality of mobile devices are detected and it is determined whether the locational relation between the plurality of mobile devices satisfy a predetermined assessment condition, and monitoring systems are switched based on the result of the determination. The assessment condition can, for instance, be whether the locations of the plurality of mobile devices are within a predetermined area, or whether the locations of the plurality of mobile devices belonging to a particular group are within a predetermined area, or whether the plurality of mobile devices are on a predefined route.

However, though the monitoring systems can be switched based on the locations of the mobile devices in the existing technology, there is no way of providing information customized to a group of individuals.

### SUMMARY OF THE INVENTION

It is an object of the present invention to at least partially solve the problems in the conventional technology.

According to an aspect of the present invention, there is provided an information providing system that provides information to a plurality of users that form a group at a given time, the information being customized to a type of the group. The information providing system includes a transmitting device configured to be carried by each of the users, stores therein user identification data that is unique to a user that carries the user-identification-data storage device, and transmits the user identification data; a receiving device that receives user identification data from the transmitting devices; a user-data storage device that stores therein correspondence relation data formed by associating personal data of each of the users with user identification data of each of the users; a contents storage device that stores therein contents associated with each of a plurality of predetermined group types; a group determining device that determines an instantaneous group the users have formed at a given time based on a plurality of pieces of user identification data received by the receiving device and the correspondence relation data stored in the user-data storage device, the instantaneous group being one of the predetermined group types; a contents extracting device that extracts, from the contents storage device, contents matching with the instantaneous group; and an information providing device that makes extracted contents available to the users that have formed the instantaneous group. The group determining device determines whether users hanging out together at the given time share a predetermined human relationship, and determines the instantaneous group based on the human relationship.

According to another aspect of the present invention, there is provided a method of providing information to a plurality of users that form a group at a given time, the information being customized to a type of the group. The method including each of the users transmitting user identification data that is unique to each user by uses of a transmitting device carried by each of the users; receiving the user identification data by uses of a receiving device; determining whether users hanging out together at a given time share a predetermined human relationship, based on a plurality of pieces of user identification data received by the receiving device and a correspondence relation data formed by associating personal data of each of the users with user identification data of each of the users, and determines an instantaneous group formed by the usere based on the human relationship; extracting, from among contents stored associated with a plurality of types of group, the instantaneous group being one of the predetermined group types, contents matching with the instantaneous group; and providing extracted contents to the users have formed the instantaneous group.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of an information providing system according to a first embodiment of the present invention;

FIG. 2 is a schematic for explaining how contents provided to a user change according to the companion of the user;

FIG. 3 is a schematic for explaining how a group can be registered in a personal-data storage device shown in FIG. 1;

FIG. 4 is a schematic for explaining a process of determining whether a plurality of users is hanging out together;

FIG. 5 is a drawing of examples of list display of contents provided to the users;

FIG. 6 is a schematic diagram of an information providing system according to the first embodiment;

FIG. 7 is a flowchart of a process procedure of how the information providing system according to the first embodiment provides information;

FIG. 8 is an example of contents of personal data;

FIG. 9 is an example of contents of relational data;

FIG. 10 is an example of contents of group-oriented contents data;

FIG. 11 is a schematic of an information providing system according to a second embodiment of the present invention;

FIG. 12 is a flowchart of a process procedure of how the information providing system according to the second embodiment provides information;

FIG. 13 is a schematic of an information providing system that includes a plurality of large-screen display devices;

FIG. 14 is a schematic of an information providing system that includes a plurality of registration information DBs;

FIG. 15 is a schematic of an information providing system that employs the GPS; and

FIG. 16 is a schematic of an information providing system that includes a plurality of carrier networks.

### DETAILED DESCRIPTION OF THE PREFERRED EMBODIMENTS

Exemplary embodiments of the present invention are described below with reference to the accompanying drawings. The present invention is not to be thus limited.

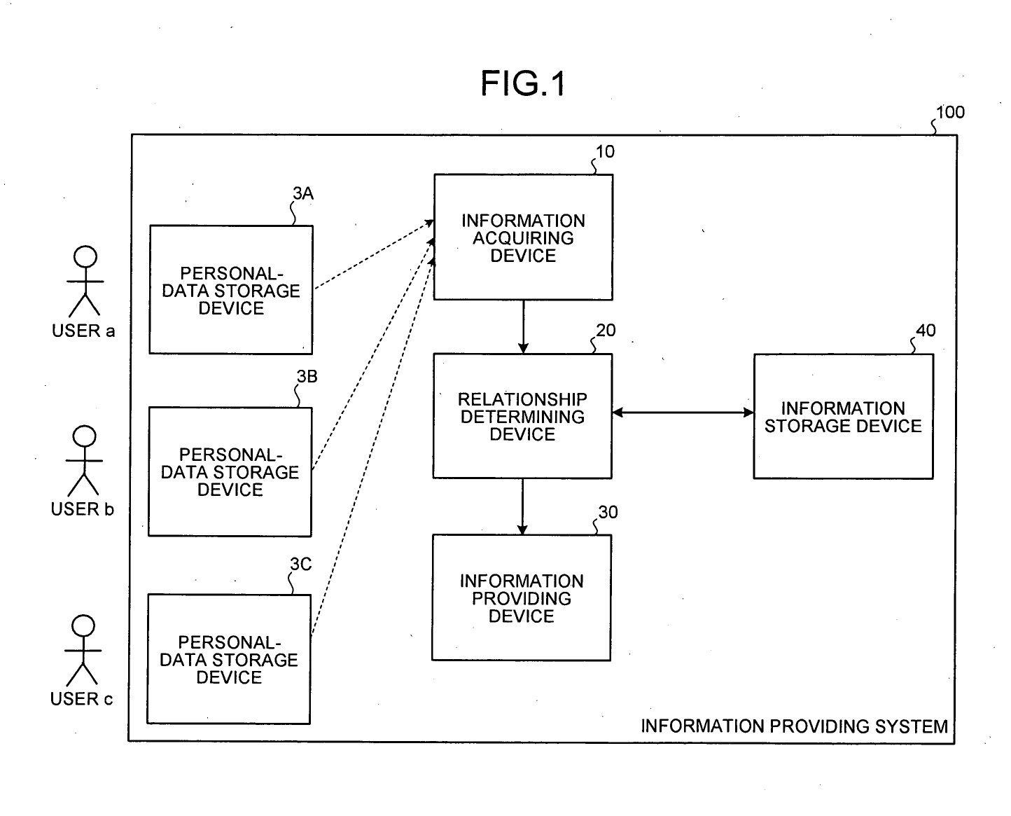

FIG. 1 is a schematic drawing of an information providing system 100 according to a first embodiment of the present invention. The information providing system 100 recognizes a plurality of users a to c, and provides information according to a group the users a to c are in the company of. Moreover, the information providing system 100, for example, recognizes a group at a predetermined location or when moving together, and provides to the individuals in the recognized group, information according to the characteristics of the group.

The information providing system 100 includes personal-data storage devices 3A to 3C, an information acquiring device 10, a relationship determining device 20, an information providing device 30, and an information storage device 40. The personal-data storage devices 3A to 3C are carried respectively by users a to c.

Each of the personal-data storage devices (user-identification-data storage devices) 3A to 3C includes a radio frequency identification (RFID) tag or a portable terminal. The personal-data storage devices 3A to 3C are capable of communicating with the information acquiring device 10 and provide information unique to the users a to c (user identification data) (hereinafter, “user ID”) to the information acquiring device 10.

The information acquiring device 10 acquires user IDs of the users a to c. The information acquiring device 10 includes an RFID reader 11, a location-information tracking server 25, etc., which are described in detail later.

The information storage device (user-data storage device, contents storage device) 40 stores therein user IDs and personal information of the users a to c. The personal information can be addresses, full names, etc. Moreover, the information storage device 40 stores therein, for every group, contents provided according to the group (such as correspondence relation data, contents). The information storage device 40 includes a registration information database (DB) 41, a contents DB 51, a group-information registration server 45, the location-information tracking server 25, etc., which are described in detail later.

The relationship determining device (group determining device, contents extracting device) 20 determines, based on the information stored in the information storage device 40, whether two or more of the users a to c are together, and if they are, then determines what relation exists between the users who are together. Moreover, the relationship determining device 20 determines the type of the group (identification of a group in a predetermined location or when moving together) between the human relationship between the users who are together. The relationship determining device 20 extracts contents from the information storage device 40 according to the determined type of group. The relationship determining device 20 includes a relationship determining unit 21, the group-information registration server 45, etc., which are described in detail later.

The information providing device 30 makes available contents data extracted from the information storage device 40 to the users a to c, and includes an information displaying unit 31, an information distribution server 35, etc., which are described in detail later.

Thus, the user IDs and personal information of the users a to c are stored in the information storage device 40 beforehand. The information acquiring device 10 acquires user IDs of the users a to c from the personal-data storage devices 3A to 3C. The relationship determining device 20 determines whether the users a to c belong to any group sharing a predetermined human relationship (group of related individuals hanging out together). The relationship determining device 20 determines, based on the user IDs and the personal information of the users a to c stored in the information storage device 40, whether the users a to c belong to a group sharing a predetermined human relationship. If the users a to c form a group located at a predetermined spot or which is moving together, and further form a group sharing a predetermined human relationship, the relationship determining device 20 extracts from the contents storage device 50, the contents corresponding to the group sharing the predetermined human relationship.

The information providing device 30 makes available the contents extracted by the relationship determining device 20 from the information storage device 40 to the users a to c by displaying the contents in a large-screen display device or distributing the contents to a mobile phone.

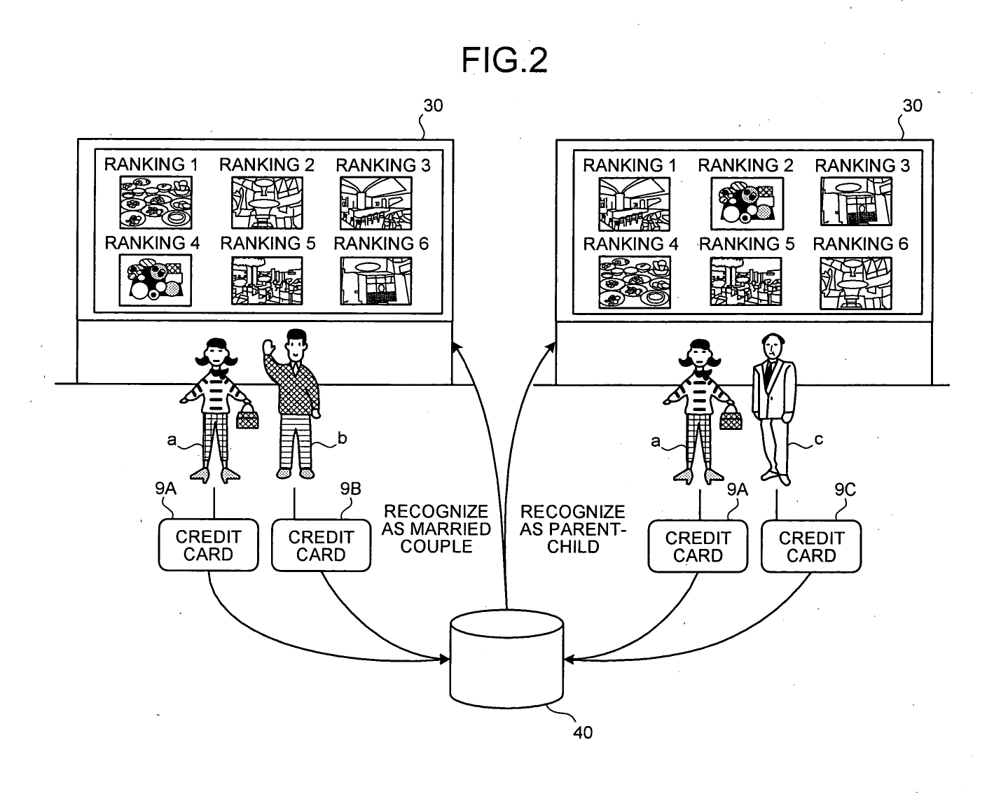

FIG. 2 is a schematic for explaining how the contents provided to the user change according to the companion of the user. In the example shown in FIG. 2, the personal-data storage devices 3A to 3C carried respectively by the users a to c are credit cards 9A to 9C.

The information providing system 100 recognizes, based on the data stored in the credit cards 9A and 9B as well as from the information stored in the information storage device 40, that the users a and b belong to a predetermined group “couple”, and through the information providing device 30, makes available to the users a and b contents corresponding to the group “couple”.

The information providing system 100 recognizes, based on the data stored in the credit cards 9A and 9C as well as the information stored in the information storage device 40, that the users a and c share a parent-child relation, and through the information providing device 30, makes available to the user a and c contents corresponding to the group “parent-child”.

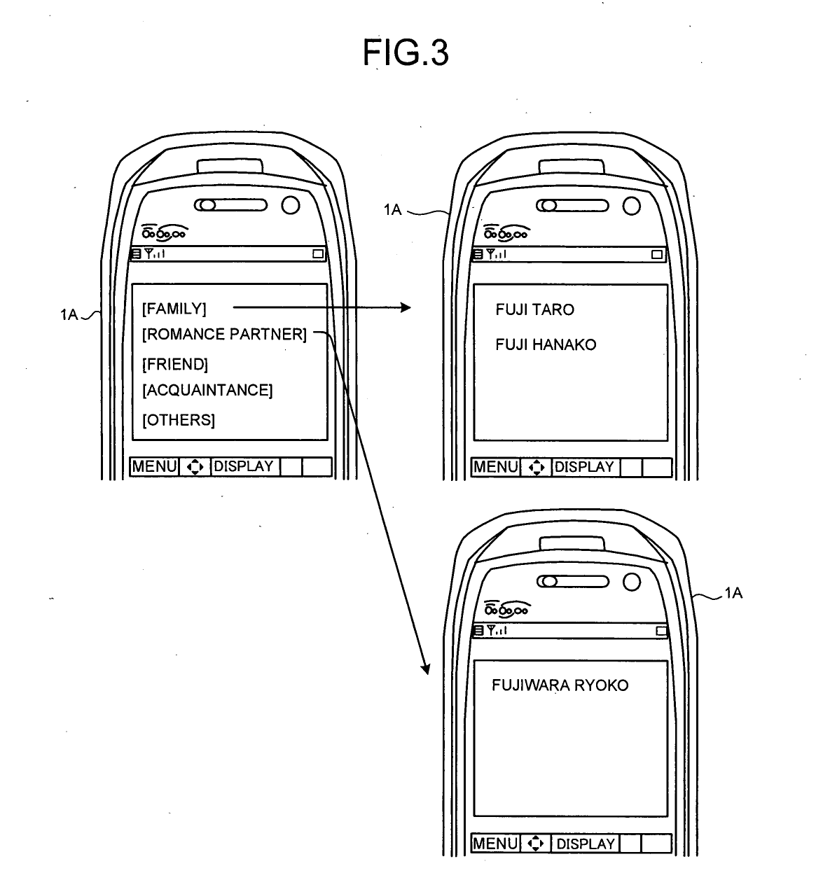

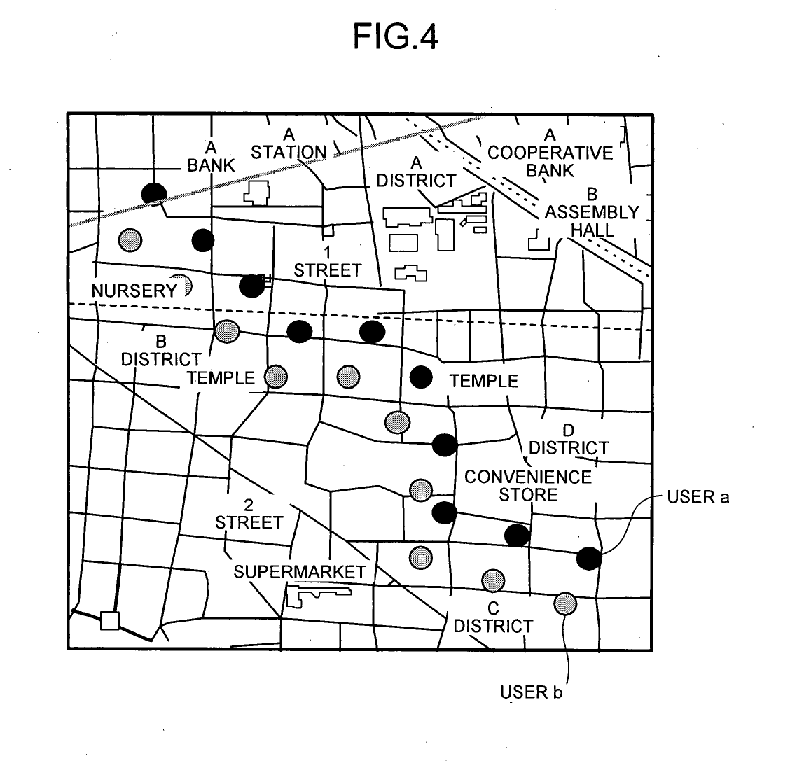

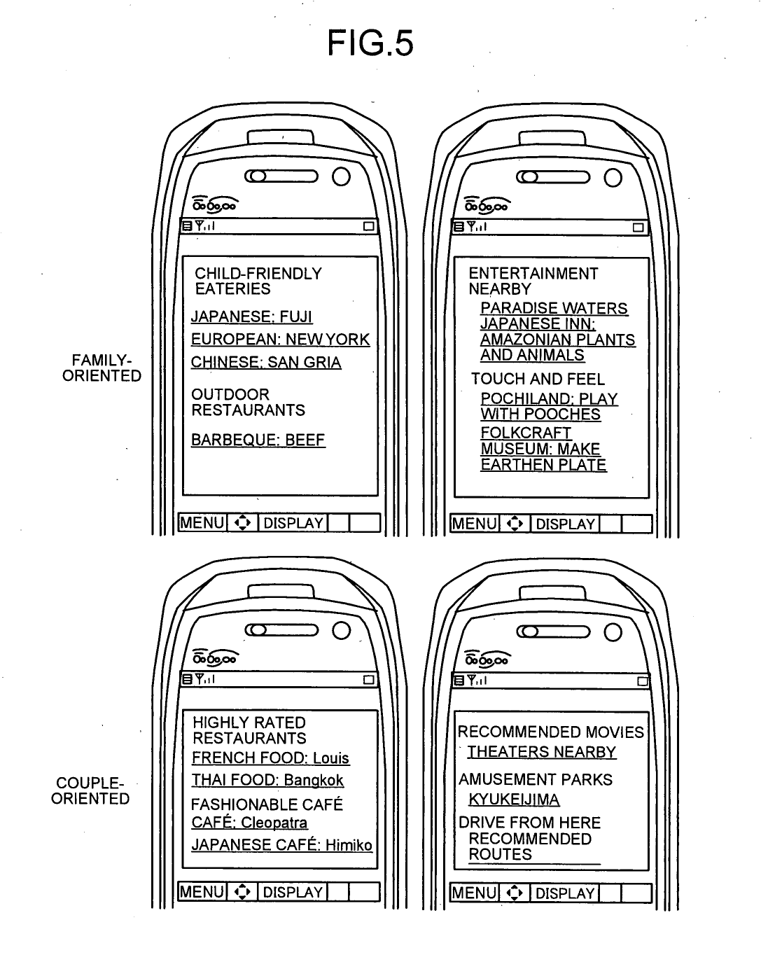

A concept of providing contents to a group that is participating in a common activity (for example, moving) is explained below. FIG. 3 is a schematic for explaining group registration in a personal-data storage device. FIG. 4 is a schematic for explaining the process of determining whether a plurality of users is hanging out together by tracking the locations of the users. FIG. 5 is a drawing of examples of list display of contents provided to the users.

A user, for instance, registers his/her contacts to predetermined groups. That is, using a grouping function provided in the personal-data storage devices, the user stores each contact under a predetermined group. For example, the user a has stored in the address book of the mobile phone all the contacts under one or the other the preset categories. In the example shown in FIG. 3, the user a stores “Fuji Taro”, who is the user b, under the category “family”, and stores “Fujiwara Ryoko”, who is the user c, under the category “romance partner”.

Data pertaining to the group entries are sent beforehand from the personal-data storage devices 3A to 3C to the information storage device 40. In this way, the human relationships amongst the users a to c are entered in the information storage device 40. During group entry, instead of names, the user can also enter the addresses of the acquaintances in the preset categories. In other words, each of the users a to c can upload the addresses to the server.

When the user a connects to the information acquiring device 10, the information acquiring device 10 recognizes the user a and tracks the location of the user a, and the relationship determining device 20 determines whether the user a is moving together with the user b or c.

If it is determined that the user a is together with the user b, the relationship determining device 20 determines the group relation amongst the users a and b based on the information stored in the information storage device 40. The relationship determining device 20 then extracts from the information storage device 40 the contents to be made available to the user a, according to the type (characteristics) of the group relation amongst the users a and b who are in each other's company.

The contents extracted from the information storage device 40 is made available to the user a when the information providing device 30 distributes the contents to the mobile phone of the user a. The information providing device 30, for example, as shown in FIG. 5, provides to the user a family-oriented contents when the user a is with the user b, or provides couple-oriented contents when the user a is with the user c. The user a then selects the desired item from this list and acquires further information regarding the selected item. Thus, the information providing system 100 provides contents to the users a to c according to the group relation amongst the individuals forming the group.

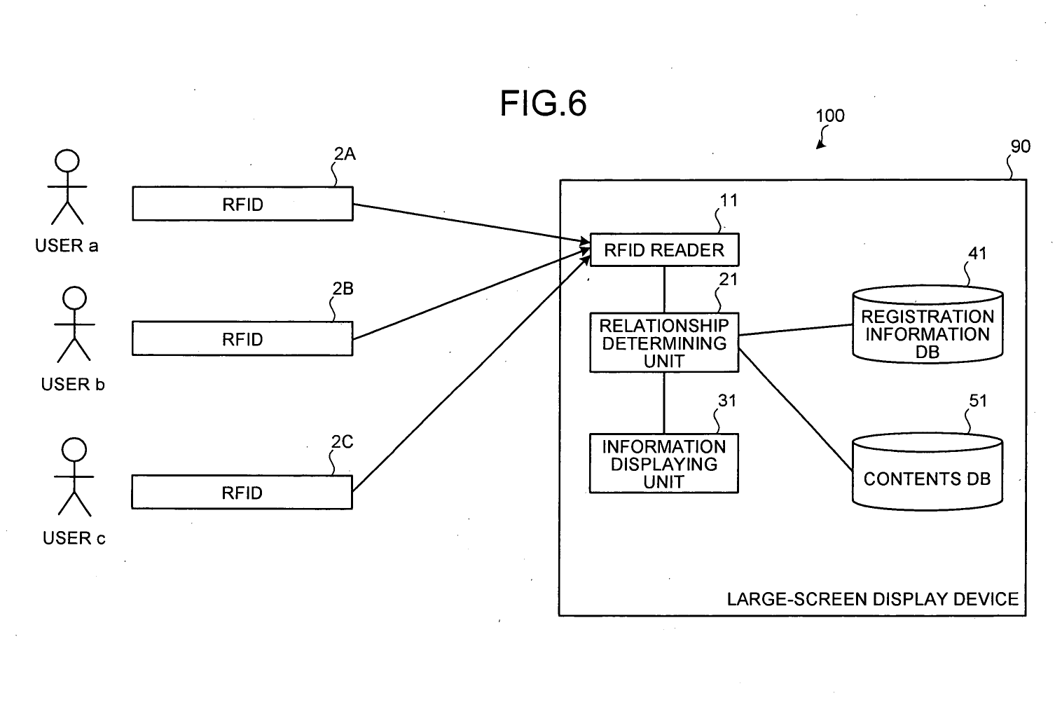

FIG. 6 is a detailed structural diagram of the information providing system 100. The information providing system 100 includes RFIDs (RFID tags) 2A to 2C being carried respectively by the users a to c, and a large-screen display device 90. The RFIDs 2A to 2C can be in the form of cards. The RFIDs 2A to 2C correspond to user-identification-data storage devices.

The RFIDs 2A to 2C are RFIDs of ultra high frequency (UHF) band or Active RFID. When being issued to the respective users, various kinds of information regarding the user are registered in the RFIDs 2A to 2C. The RFIDs 2A to 2C can, for instance, be family-members cards or corporate cards issued by companies providing predetermined services. The data registered in such family-members cards or corporate cards is used as personal information of the users a to c stored in the RFIDs 2A to 2C.

The large-screen display device 90 is a device that displays predetermined information (contents) for the benefit of the users who are in its vicinity. The large-screen display device 90 can, for instance, be a restaurant-list display screen installed in a restaurant street. The large-screen display 90 device includes the RFID reader 11, the relationship determining unit 21, the information displaying unit 31, the registration information DB 41, and the contents DB 51.

The RFID reader 11 corresponds to an information acquiring device. The relationship determining unit 21 corresponds to a group determining device and a contents extracting device. The information displaying unit 31 corresponds to a user-data storage device. The registration information DB 41 corresponds to an information providing device. The contents DB 51 corresponds to a contents storage device.

When the RFIDs 2A to 2C come within a predetermined distance (say, two meters) from the large-screen display device 90 (and hence from the RFID reader 11), the RFID reader 11 reads the information (the user ID) registered in the RFIDs 2A to 2C. By recognizing the RFIDs 2A to 2C located near the large-screen display device 90, the RFID reader 11 recognizes the users a to c carrying the RFIDs 2A to 2C.

The registration information DB 41 stores therein information (such as personal data 200, and relational data 210, which are described later) used for determining the type of group the users a to c, already registered in the registration information DB 41, would form. The registration information DB 41, for instance, stores therein, as the personal data 200, various kinds of information (personal data, etc.) corresponding to each user ID.

The relationship determining unit 21 determines, based on the user IDs of the users a to c read by the RFID reader 11 and the information stored in the registration information DB 41, whether the users a to c form a group sharing a predetermined relationship. The relationship determining unit 21, for instance, may determine that the users a to c are friends and form a group called “Friends”. The relationship determining unit 21 then extracts the contents from the contents DB 51 based on the type of group the users a to c are determined to form.

The information displaying unit 31 displays the contents extracted by the relationship determining unit 21, and can include a liquid crystal display device or a plasma display device. The information displaying unit 31 may display as information pertaining to restaurants suitable for the users a to c, for example, reasonably-priced much-talked-about restaurants.

In the example shown in FIG. 6 the registration information DB 41 and the contents DB 51 are incorporated in the large-screen display device 90, however, they may be provided outside the large-screen display device 90 or incorporated in an external device, such as a server (for example, contents server). When such a configuration is employed, the relationship determining unit 21 of the large-screen display device 90 can be configured to acquire the data stored in the contents DB 51 by accessing the external device.

Furthermore, in the example shown in FIG. 6, although the RFID reader 11 and the relationship determining unit 21 are incorporated in the large-screen display device 90, they may be provided in another device.

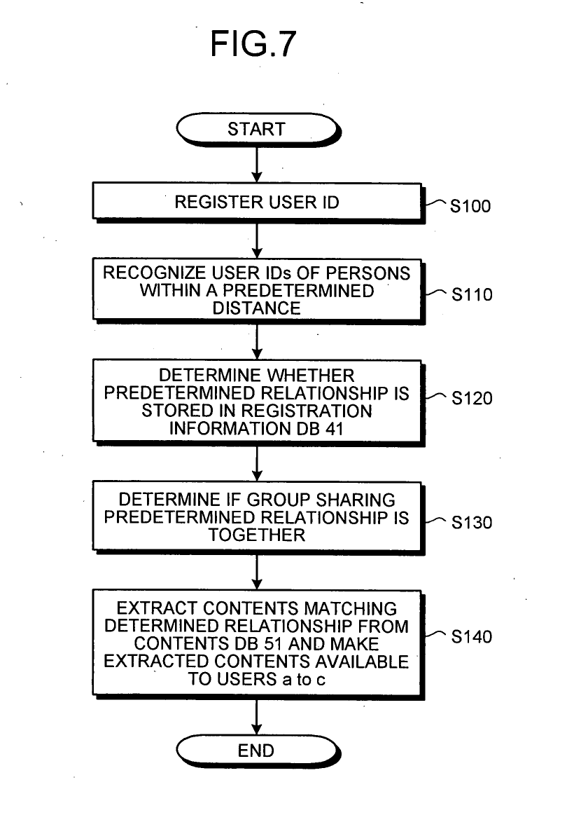

A process procedure of how the information providing system according to the first embodiment provides information is described below. FIG. 7 is a flowchart of the process procedure of how the information providing system according to the first embodiment provides information. The registration information DB 41 already has stored therein personal information and the user IDs of the users a to c (step S100).

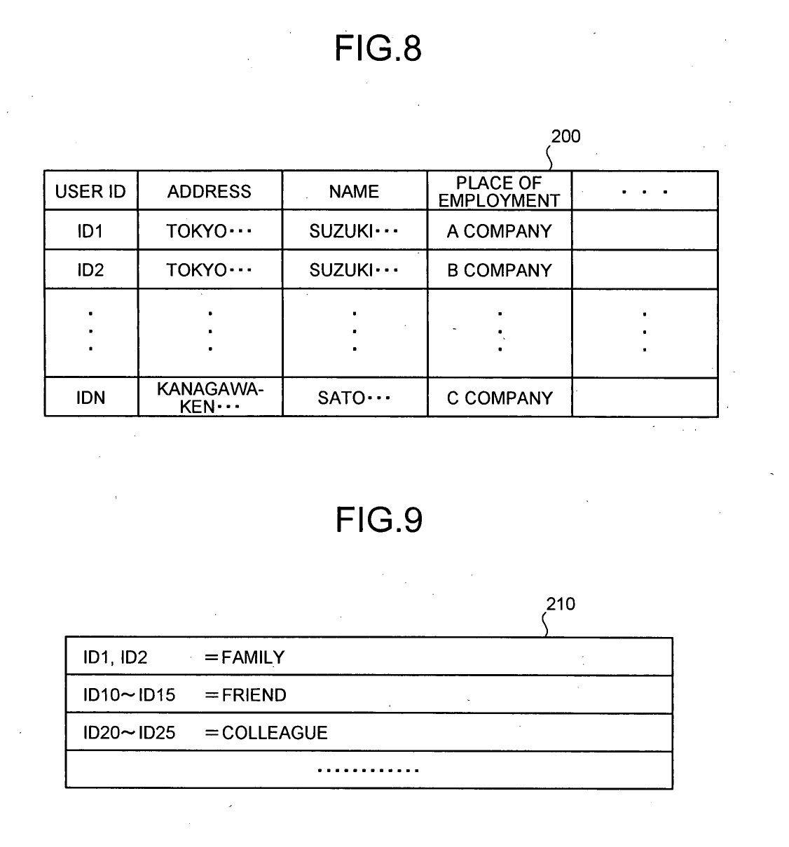

The information stored in the registration information DB 41 (the personal data 200, the relational data 210) is described below. FIG. 8 is a drawing of the contents of the personal data stored in the registration information DB. FIG. 9 is a drawing of the contents of the relational data stored in the registration information DB.

The personal data 200 is personal information pertaining to every user ID, and includes the address, full name, place of employment, etc. of each user. The relational data 210 indicates groups formed by a plurality of user IDs. In the example shown in FIG. 9, the group formed by the users with user IDs 1 and 2 is that of individuals related to each other, forming a “family” group. Similarly, the group formed by the users with user IDs 10 to 15 is that of individuals who are friends, forming a “friends” group. Likewise, the group formed by the users with user IDs 20 to 25 is that of individuals who are colleagues, forming a “colleagues” group.

The RFID reader 11 reads the RFIDs 2A to 2C carried by the users a to c when the users a to c come within a predetermined distance from the RFID reader 11, and acquires the user IDs of the users a to c (step S110).

The relationship determining unit 21 determines whether the users a to c belong to a group sharing a predetermined human relationship (whether the users a to c are hanging out together) based on the user IDs of the users a to c, the personal data 200, and the relational data 210 stored in the registration information DB 41 (step S120). A group itself is recognized based on whether there exists any human relationship amongst the plurality of users.

The process of determination of existence of a group by the relationship determining unit 21 based on the personal data 200 is described below. If departments in the place of employment corresponding to the user IDs of the users a and b are the same, the relationship determining unit 21 surmises the users a and b are members of the same company. Then, based on the designations of the users a and b, the relationship determining unit 21 determines whether, in addition to being members of the same company, the users a and b share a boss-subordinate human relationship or a colleagues human relationship (forming a boss-subordinate group or a colleague group).

The process of determination of existence of a group by the relationship determining unit 21 based on the relational data 210 is described below. If the user ID of the user a is ID 1 and the user ID of the user b is ID 2, the relationship determining unit 21 surmises that the users a and b are members of one family.

Groups recognized by the relationship determining unit 21 based on the user IDs of the users a to c and the personal data 200 and the relational data 210 are based on blood relations, relationships based on association, or relationships based on societal interactions. Examples of blood relations include relationships such as those of parent-child, husband-wife, grandparent-grandchild, and family. Examples of association-based human relationships include relationships such as those of romance partners, friends (opposite sex), friends (same sex), and acquaintances. Examples of human relationships based on societal interactions are those of colleagues, boss-subordinate of a company, customer-trader, teacher-student, etc.

Apart from the relations mentioned above, other relations such as those between people who frequently drink together, or who play a specific sport, or travel together can also be included as groups recognized by the relationship determining unit 21.

Once it is determined that the users a to c are at a predetermined spot and share a predetermined human relationship (step S130), the relationship determining unit 21 extracts the contents corresponding to the human relationship shared by the members of the group, based on the group, and the information (group-oriented contents data 220, which is described later) stored in the contents DB 51.

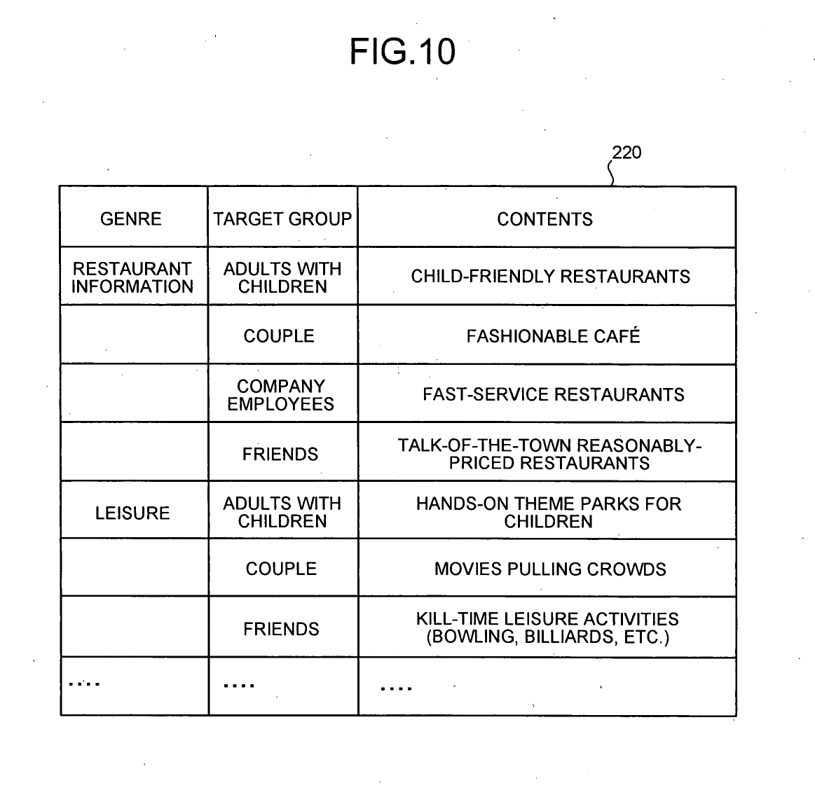

The group-oriented contents data 220 stored in the contents DB 51 is described below. FIG. 10 is a drawing of the contents of the group-oriented contents data.

The group-oriented contents data 220 contains information under different categories, each category customized to the groups to which contents are provided (target groups). In other words, the group-oriented contents data 220 of the contents DB 51 contains contents that are associated with a predetermined group relation. For example, under the category of “restaurant information”, the contents related to “restaurants with a wide choice of menu and child-friendly seating” are stored associated with the target group of “family”.

The contents and the groups can also be manually associated based on fact-based inference (for example, “a particular family visits Restaurant A frequently”).

In the example shown in FIG. 10, under the category “restaurant information”, contents related to “child-friendly restaurants” are associated with the group “with child/children”. Also, under the category “leisure”, contents related to “much-talked-about movies” are associated with the group “couple”.

If it is determined that the users a to c form a “friends” group, the relationship determining unit 21 extracts contents from the contents DB 51 related to “talk-of-the-town reasonably-priced restaurants” associated with the category “restaurant information” and “kill-time leisure activities (bowling, billiards, etc.)” associated with the category “leisure”. The relationship determining unit 21 can be configured to extract contents associated with specific categories from the contents DB 51, either automatically according to the place and time at which information is provided to the user or in accordance with specification of the category by the user.

The information displaying unit 31 makes available the contents extracted by the relationship determining unit 21 to the users a to c by displaying the contents (step S140). The information displaying unit 31 can be configured to display the group-oriented contents in large fonts or in any eye-catching manner so as to instantly draw attention to the information.

The information providing system 100 is so far described as making available contents to three users a to c. The information providing system 100 can also be configured to provide contents to two or more, or four or more users. In these cases too, personal data for every user is stored beforehand in the registration information DB 41, group determination is carried out based on the user IDs, and contents are made available to the users according to the group they form.

In the first embodiment, the group-oriented contents data 220 is stored in the contents DB 51 of the large-screen display device 90. However, the group-oriented contents data 220 can be stored in an external device such as a contents server, and the relationship determining unit 21 can be configured to acquire the group-oriented contents data 220 from the contents server by connecting to the Internet.

Thus, according to the first embodiment, when the group formed by the users a to c is located at a predetermined spot, contents are made available to the users a to c according to the type of group (relationship amongst the users a to c) the users a to c form. Consequently, contents are made available to the users a to c more according to the circumstance they are in rather than according to their individual personal preferences.

By providing contents according to the type of group, the contents provider is able to create contents at a lower cost than when contents are to be customized to every user, in addition to increasing the hit ratio of accessing the contents by the users, effectively making the contents available to the users forming predetermined groups.

When making information available to a plurality of users in the vicinity within a specified range of the large-screen display device 90, the information that is likely to grab the user's attention is displayed on priority, making the process a very effective one for both the providing party and the target party (the user).

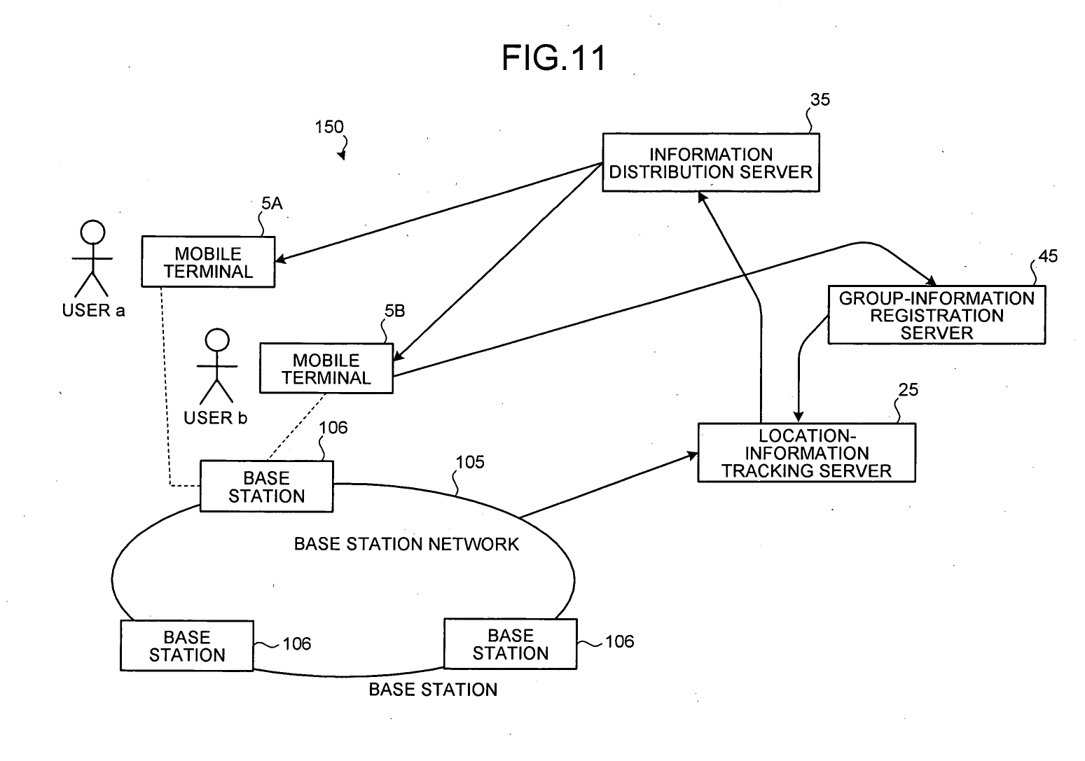

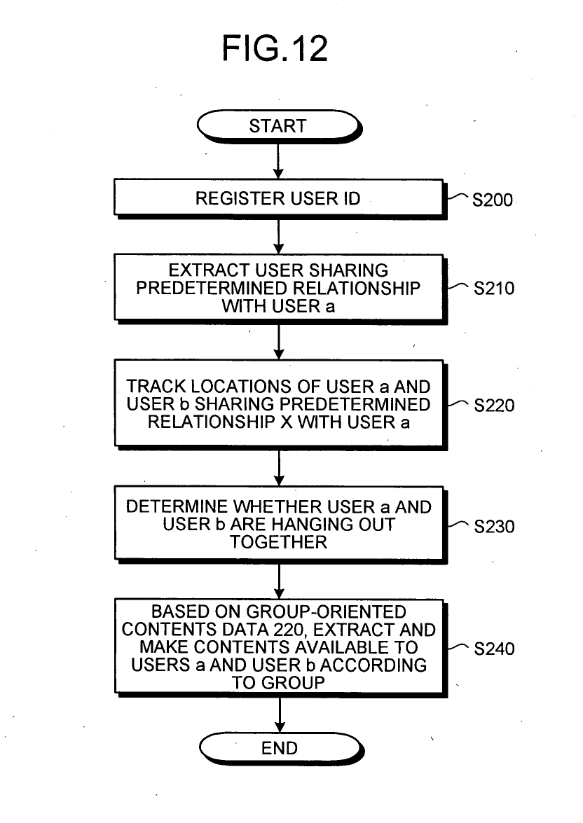

A second embodiment of the present invention is described below with reference to FIGS. 11 and 12. In the second embodiment, whether the users a and b form a predetermined group is determined based on the information transmitted by mobile terminals being carried by the users a and b, respectively. The mobile terminals 5A and 5B correspond to the personal-data storage devices 3A and 3B, respectively, of the first embodiment shown in FIG. 1.

FIG. 11 is a schematic of the information providing system according to the second embodiment. An information providing system 150 according to the second embodiment consists of the mobile terminals 5A and 5B, a base station network (communication network) 105, a location-information tracking server (location-information acquiring device) 25, the information distribution server 35, and the group-information registration server 45.

The mobile terminals 5A and 5B are mobile phones or personal handyphone systems (PHS) and are connected to the information distribution server 35. The mobile terminals 5A and 5B register information related to personal data or predetermined groups (that is, data related to users forming predetermined groups) in the group-information registration server 45, as well as receive from the information distribution server 35 contents customized to the group the users a and b form.

The group-information registration server 45 corresponds to the information storage device 40 (the registration information DB 41) of the first embodiment. The group-information registration server 45 keeps ready the personal data 200 and the relational data 210 created based on the information already registered by the users a and b through their respective mobile terminals 5A and 5B. The phone numbers of the mobile phones themselves can be used as user IDs in the personal data 200 and the relational data 210.

The base station network 105 consists of a plurality of base stations 106 connected to one another and each of the base stations 106 is connected to the mobile terminals 5A and 5B. The base station network 105 connects with and transmits to the location-information tracking server 25 information related to the base station 106 to which the mobile terminals 5A and 5B are connected.

The location-information tracking server 25 is equipped with a function of detecting the locations of the mobile terminals 5A and 5B based on the information received from the base station network 105, and tracks the locations of the mobile terminals 5A and 5B based on the location of the base station 106 with which the mobile terminals 5A and 5B connect. In addition to determining whether the users a and b form a predetermined group based on the personal data 200 and the relational data 210, the location-information tracking server 25 also determines whether the users a and b are hanging out together. In other words, the location-information tracking server 25 is equipped with the function corresponding to that of the relationship determining device 20 (the relationship determining unit 21) of the first embodiment. The location-information tracking server 25 surmises that the users a and b are together if while tracking the mobile terminals 5A and 5B, their tracks are found to be within a predetermined range.

The information distribution server 35 corresponds to the information providing device 30 (the contents DB 51 and the information displaying unit 31). In other words, the information distribution server 35 distributes contents based on the group-oriented contents data 220 to the users a and b (the mobile terminals 5A and 5B) if the users a and b are determined by the location-information tracking server 25 to form a predetermined group.

A process procedure of how the information providing system according to the second embodiment provides information is described below. In this example, it is assumed that the user b, who along with the user a forms a group, is hanging out with the user a.

FIG. 12 is a flowchart of the process procedure of how the information providing system according to the second embodiment provides information. The users a and b access the group-information registration server 45 through the mobile terminals 5A and 5B, and transmit the user IDs, personal data, information related to group entries made in their respective mobile terminals 5A and 5B, etc. The group-information registration server 45 creates and stores therein the personal data 200 and the relational data 210 created based on the information received from the mobile terminals 5A and 5B (step S200).

Each base station 106 of the base station network 105 recognizes the location of the user a (the mobile terminal 5A) within a communication area of the base station 106, and transmits information related to the location of the mobile terminal 5A to the location-information tracking server 25.

The location-information tracking server 25 extracts the user forming a group with the user a (in this example, the user b) based on the personal data 200 and the relational data 210 (step S210). The location-information tracking server 25 tracks the location of the mobile terminals 5A and 5B based on the location of the base station 106 with which the mobile terminals 5A and 5B connect (step S220). By tracking the locations of the mobile terminals 5A and 5B, the location-information tracking server 25 determines whether the users a and b are hanging out together (step S230).

Once it is determined that the users a and b form a group based on a predetermined relation, the location-information tracking server 25 transmits the information related to the group to the information distribution server 35.

The information distribution server 35 extracts, based on the group-oriented contents data 220, the contents corresponding to the information related to the group received from the location-information tracking server 25 and makes the extracted contents available (distributes the contents) to the users a and b (step S240).

In the information providing system 150, if the mobile terminals 5A and 5B are mobile phones, the base station network 105 can be contracted as the communication network for the mobile phones, and one of or all of the location-information tracking server 25, the information distribution server 35, and the group-information registration server 45 can function as the provider for the mobile phones.

Thus, according to the second embodiment, contents customized to group characteristics are made available to the users a and b, who form a group and are determined to be hanging out together.

Although the invention has been described with respect to a specific embodiment for a complete and clear disclosure, the embodiments are not to be limited but are to be construed as embodying all modifications and alternative constructions that may occur to one skilled in the art which fairly fall within the basic teaching herein set forth.

For example, the information providing system 100 in the first embodiment includes the large-screen display device 90 having the registration information DB 41 and the contents DB 51. However, an information providing system (an information providing system 101, described later) can be configured to include a plurality of large-screen display devices, with each large-screen display device having its own registration information DB 41 and the contents DB 51.

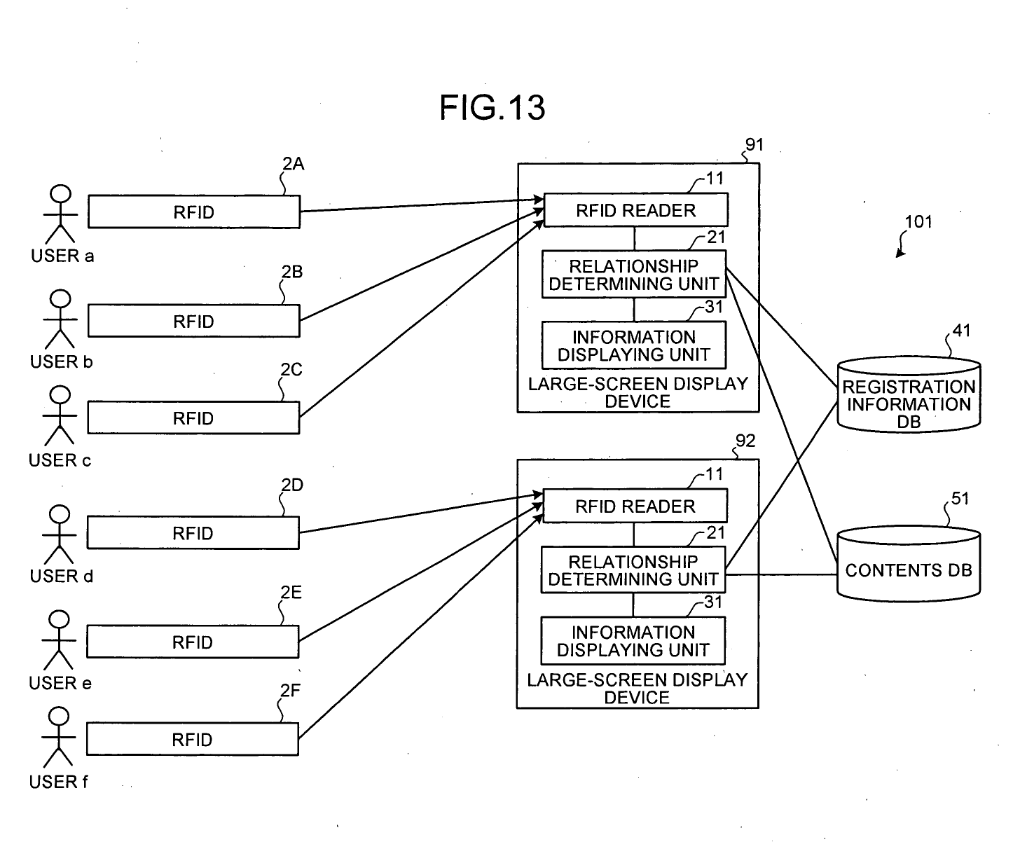

FIG. 13 is a schematic of an information providing system that includes a plurality of large-screen display devices. The elements in FIG. 13 that have the same functionality as those of the information providing system 100 according to the first embodiment shown in FIG. 6 are assigned the same reference numerals and symbols and are not described here.

The information providing system 101 includes RFIDs 2A to 2F carried by users a to f and large-screen display devices 91 and 92. The RFIDs 2D to 2F function exactly like the RFIDs 2A to 2C. It is assumed here that the RFID reader 11 of the large-screen display device 91 reads the information stored in the RFIDs 2A to 2C while the RFID reader 11 of the large-screen display device 92 reads the information stored in the RFIDs 2D to 2F.

Each of the large-screen display devices 91 and 92 includes the RFID reader 11, the relationship determining unit 21, and the information displaying unit 31. In the example shown in FIG. 13, each of the large-screen display devices 91 and 92 is connected to the same registration information DB 41 and the contents DB 51. In other words, the registration information DB 41 and the contents DB 51 are common to both the large-screen display devices 91 and 92.

Thus, the large-screen display devices 91 and 92 recognize the RFIDs 2A to 2C and the RFIDs 2D to 2F carried respectively by the users a to c and the users d to f, forming two different groups, and make available contents customized to each group based on the information stored in the registration information DB 41 and the contents DB 51.

Thus, even if the information providing system 101 includes a plurality of large-screen display devices 91 and 92, the configuration is simple in that, each of the large-screen display devices 91 and 92 recognizes and displays the contents customized to designated groups. The number of large-screen display devices need not be restricted to two and can also be three or more.

In the information providing system 100 according to the first embodiment, the relationship determining unit 21 acquires the personal data 200 and the relational data 210 from the registration information DB 41. However, an information providing system can be configured in which the registration information DB 41 of the information providing system 100 is connected to external registration information DBs (registration information DBs 43A and 43B, described later), and the registration information DB 41 acquires various kinds of personal information, etc. from the external registration information DBs to create and store the personal data 200 and the relational data 210. The relationship determining unit 21, which directly accesses the registration information DB 41, can be included as a part of the large-screen display device 91 or can be provided as a separate entity.

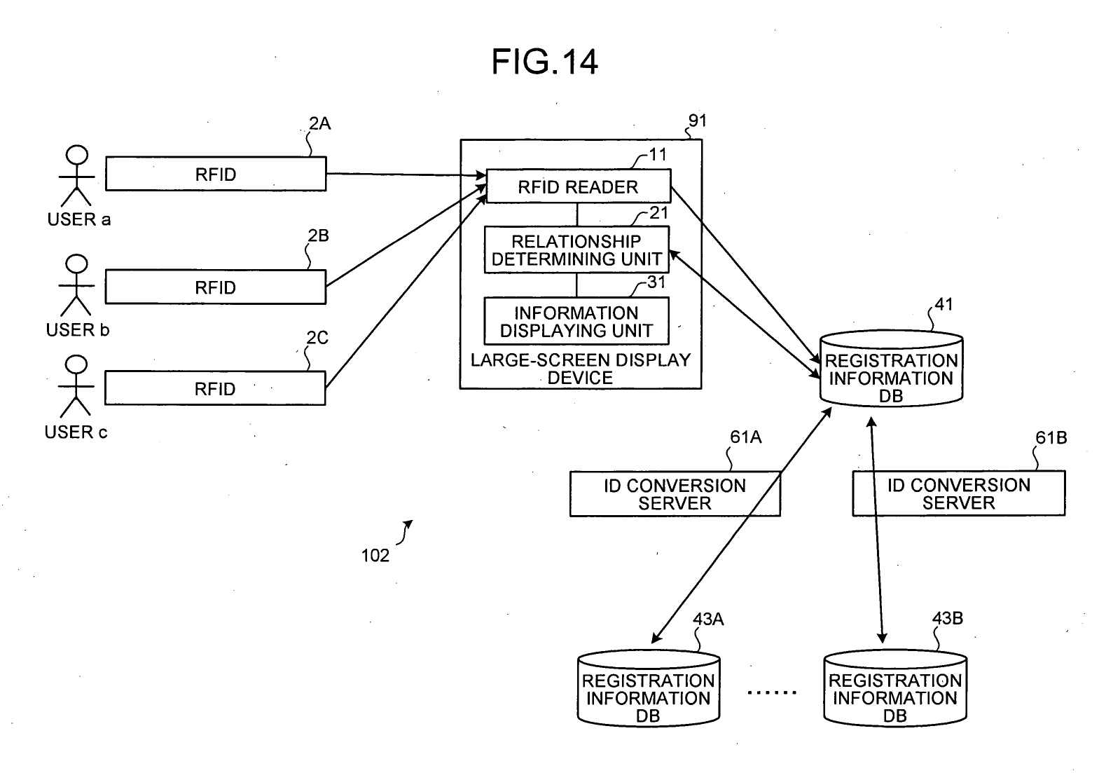

FIG. 14 is a schematic of an information providing system that includes a plurality of registration information DBs. The elements in FIG. 14 that are identical to those in the information providing system 100 shown in FIG. 6 and the information providing system 101 shown in FIG. 13 have been assigned the same reference numerals and symbols and are not described here. The contents DB 51 is not shown in FIG. 14.

As shown in FIG. 14, an information providing system 102 includes the RFIDs 2A to 2C carried respectively by the users a to c, the large-screen display device 91, the registration information DB 41, ID conversion servers 61A and 61B, and the registration information DBs 43A and 43B. The registration information DB 43A is connected to the registration information DB 41 through the ID conversion server 61A, and the registration information DB 43B is connected to the registration information DB 41 through the ID conversion server 61B.

The ID conversion servers 61A and 61B associate the user IDs included in the personal data 200 and the relational data 210 stored in the registration information DB 41 and the user IDs in the personal information, etc. stored in the registration information DBs 43A and 43B. In other words, the ID conversion servers 61A and 61B extract from the registration information DBs 43A and 43B the personal data corresponding to the user ID, based on the user ID stored in the registration information DB 41, transmits the personal data to the registration information DB 41. The personal data that is stored in the registration information DBs 43A and 43B but that does not have an associated user ID in the registration information DB 41 can be transmitted as it is to the registration information DB 41 without the association process by the ID conversion servers 61A and 61B.

Thus, the registration information DB 41 can acquire personal information from the registration information DBs 43A and 43B provided externally, and create and keep ready a detailed personal data 200 and the relational data 210, enabling the relationship determining unit 21 to determine whether the users a to c form a predetermined group based on the detailed personal data 200 and the relational data 210.

Thus, by determining whether the users a to c form a predetermined group based on the detailed personal data 200 and the relational data 210, the information providing system 102 is able to provide contents customized to the group.

In the information providing system 102, the registration information DBs 43A and 43B can be configured to provide personal data to the registration information DB 41 in response to a request for the same by the registration information DB 41. Alternatively, the registration information DBs 43A and 43B can proactively send personal data to the registration information DB 41.

Further, in the information providing system 102, instead of the registration information DB 41 acquiring the personal information from the registration information DBs 43A and 43B, the relationship determining unit 21 can be configured to directly acquire the personal data 200 and the relational data 210 from the registration information DBs 43A and 43B.

Further, instead of two registration information DBs 43A and 43A, the information providing system 102 can include one registration information DB or three or more registration information DBs. Also, one ID conversion server can be connected to a plurality of registration information DBs instead of one registration information DB.

In the second embodiment, the information providing system 150 detects the location of the users a and b based on the information received from the base station 106 of the base station network 105. However, the information providing system 150 can be configured to detect the location of the users a and b based on Global Positioning System (GPS).

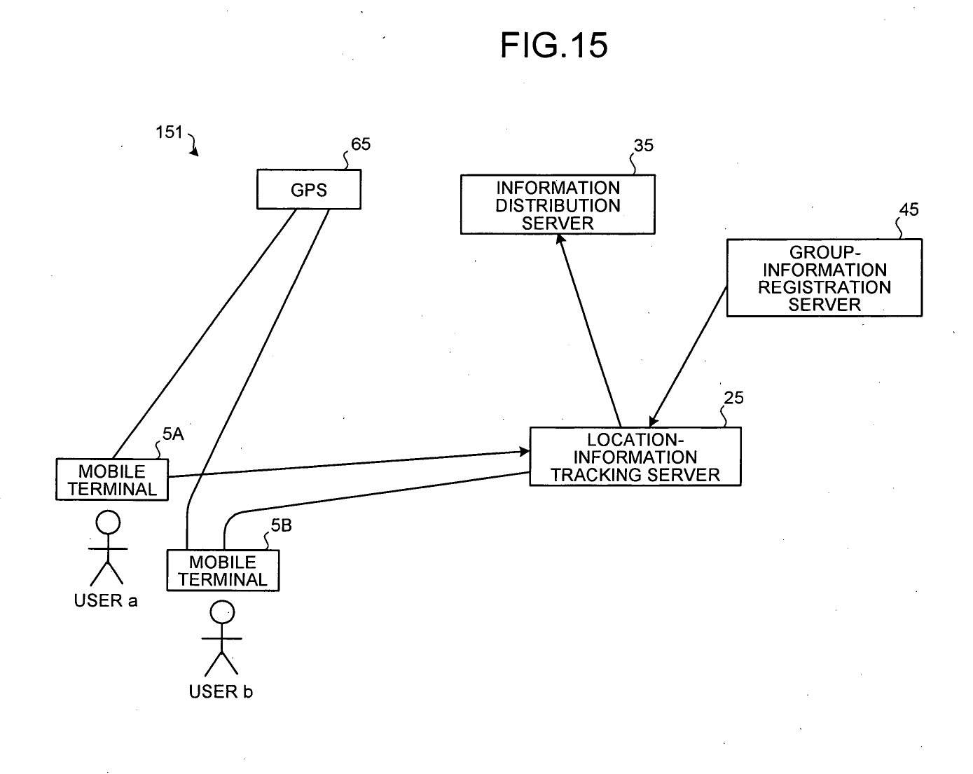

FIG. 15 is a schematic of an information providing system that employs the GPS. The elements in FIG. 15 that are identical to those of the information providing system 150 according to the second embodiment shown in FIG. 11 are assigned the same reference numerals and symbols and are not described here.

An information providing system 151 includes the mobile terminals 5A and 5B carried respectively by the users a and b, Global Positioning system (GPS) 65, the location-information tracking server 25, the information distribution server 35, and the group-information registration server 45.

The GPS 65 is a set of artificial satellites that detects the locations of the mobile terminals 5A and 5B and transmits to the mobile terminals 5A and 5B information related to their locations. The mobile terminals 5A and 5B are equipped with the functionality enabling them to be located by the GPS 65 and to receive information related to their location from the GPS 65. The mobile terminals 5A and 5B then pass on the information related to their location received from the GPS 65 to the location-information tracking server 25.

In the information providing system 151, if the mobile terminals 5A and 5B are mobile phones, one of or all of the location-information tracking server 25, the information distribution server 35, and the group-information registration server 45 can be contracted as the provider or as a third-party provider. In such a case, the mobile terminals 5A and 5B send the information related to their locations to the location-information tracking server 25 functioning as a third-party provider.

Thus, the location-information tracking server 25 is able to track the locations of the mobile terminals 5A and 5B based on the information related to the locations of the mobile terminals 5A and 5B sent by the mobile terminals 5A and 5B themselves.

As a result, if the users a and b are found to be forming a group and are together, the information providing system 151 provides contents customized to the group. Consequently, contents are made available to the users a and b more according to the circumstance they are in rather than according to their individual personal preferences.

In the information providing system 150 according to the second embodiment, the mobile terminals 5A and 5B are connected to one base station network 105. However, the information providing system 150 can be configured to include a plurality of types of carrier networks (base station networks 110A and 110B, described later) of a plurality of providers.

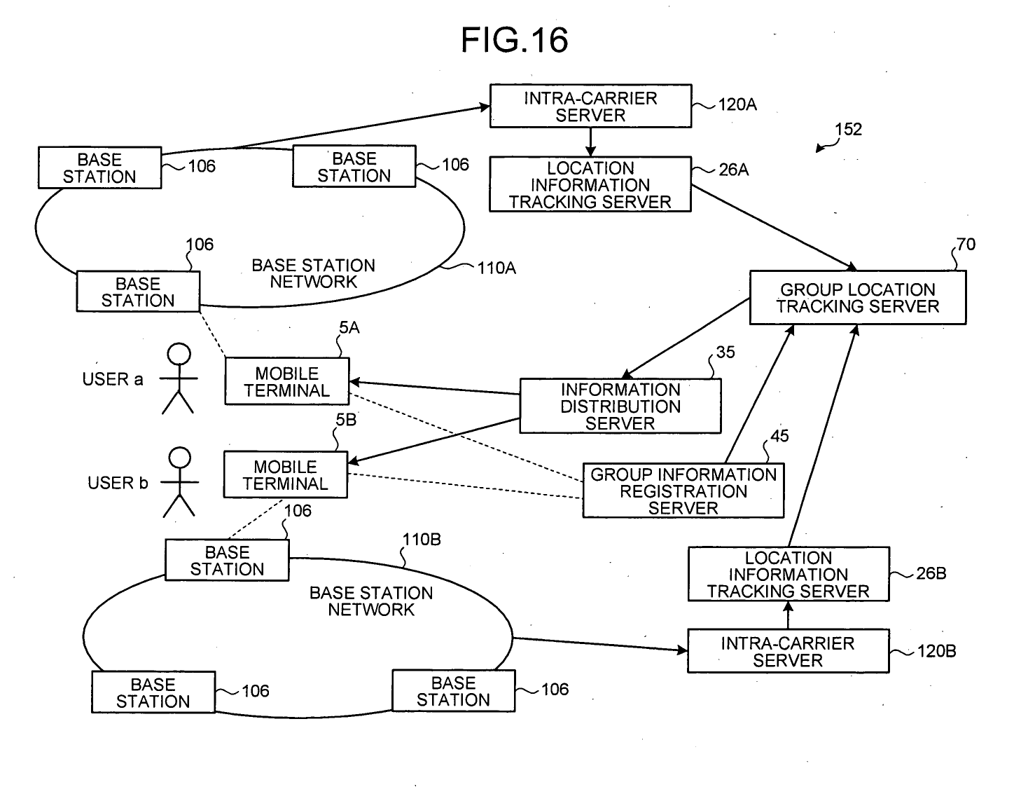

FIG. 16 is a schematic of an information providing system that includes a plurality of carrier networks. The elements in FIG. 16 that are identical to those in the information providing systems 150 and 151 shown in FIGS. 11 and 15, respectively, are assigned the same reference numerals and symbols and are not described here.

As shown in FIG. 16, an information providing system 152 includes the mobile terminals 5A and 5B carried respectively by the users a and b, the base station networks 110A and 110B, intra-carrier servers 120A and 120B, location-information tracking servers 26A and 26B, the information distribution server 35, the group-information registration server 45, and a group location tracking server 70.

The base station network 110A is connected to the location-information tracking server 26A through the intra-carrier server 120A, and the base station network 110B is connected to the location-information tracking server 26B through the intra-carrier server 120B. The location-information tracking servers 26A and 26B are equipped with the same functionality as the location-information tracking server 25 of the second embodiment.

The location-information tracking servers 26A and 26B are connected to the information distribution server 35 and the group-information registration server 45 through the group location tracking server 70. It is assumed in the example shown in FIG. 6 that the providers of the carrier networks of the base station networks 110A and 110B are different. In other words, each of the base station networks 110A and 110B can connect only with a predetermined mobile terminal. In the example shown in FIG. 6, it is assumed that the mobile terminal 5A connects with the base station 106 of the base station network 110A, and the mobile terminal 5B connects with the base station 106 of the base station network 110B. As in the second embodiment, users a and b access the group-information registration server 45 through the mobile terminals 5A and 5B, and transmit the information related to group entries made in their respective mobile terminals 5A and 5B.

The intra-carrier servers 120A and 120B connect respectively with the base station networks 110A and 110B, and manage the mobile terminals 5A and 5B that connect with the base station networks 110A and 110B, respectively.

In the information providing system 152, in addition to determining whether the users form a predetermined group based on the personal data 200 and the relational data 210, the group location tracking server 70 also determines whether the users forming the group are hanging out together. Thus, apart from storing the personal data 200 and the relational data 210, the group location tracking server 70 is equipped with the functionality of the relationship determining unit 21 explained in the first embodiment.

In other words, if the information providing system that includes only one carrier, personal data is uploaded to the server of the carrier (the group-information registration server 45). However, when a plurality of different carriers are included in the information providing system, the users using different carriers upload personal data to a service provider who is carrier-independent (the group location tracking server 70).

A process procedure of how the information providing system 152 provides information is described below. In this example, it is assumed that the user b, who along with the user a forms a group, is hanging out with the user a.

Each base station 106 in the base station network 110A recognizes the location of the user a (the mobile terminal 5A) within a communication area of the base station 106, and transmits information related to the location of the mobile terminal 5A to the location-information tracking server 26A through the intra-carrier server 120A.

Similarly, each base station in the base station network 110B recognizes the location of the user b (the mobile terminal 5B) within a communication area of the base station 106, and transmits information related to the location of the mobile terminal 5B to the location-information tracking server 26B through the intra-carrier server 120B.

The location-information tracking servers 26A and 26B track the locations of the users a and b, respectively, and transmit information related to the locations and the shift of locations of the locations of the users a and b to the group location tracking server 70.

The group location tracking server 70 extracts the user forming a group with the user a (in this example, the user b) based on the personal data 200 and the relational data 210 (step S210).

The group location tracking server 70 determines whether the users a and b are hanging out together based on the information related to the locations and the shift of locations of the users a and b received from the location-information tracking servers 26A and 26B.

If it is determined that the users a and b form a group sharing a predetermined relationship are hanging out together, the group location tracking server 70 transmits information related to the group to the information distribution server 35.

The information distribution server 35 extracts, based on the group-oriented contents data 220, the contents corresponding to the information related to the group received from the group location tracking server 70, and makes the extracted contents available to the users a and b.

Thus, even if the information providing system 152 is configured to include a plurality of base station networks 110A and 110B functioning as different carrier networks, information related to the locations of the users a and b are transmitted to the location-information tracking servers 26A and 26B through the intra-carrier servers 120A and 120B, respectively. Consequently, the location-information tracking servers 26A and 26B are able to track the locations of the mobile terminals 5A and 5B based on the information elated to the locations of the mobile terminals 5A and 5B.

Further, the location-information tracking servers 26A and 26B also transmit information related to the locations or shift of locations of the users a and b to the group location tracking server 70. Consequently, the group location tracking server 70 is able to determine whether the users a and b are hanging out together.

Thus, the information providing system 152 is able to provide contents customized to the group the users a and b forming the group are found to be hanging out together, making contents available to the users a and b more according to the circumstance they are in rather than according to their individual personal preferences.

The invention is not to be limited to the embodiments described here but are to be construed as embodying all modifications and alternative constructions that may occur to one skilled in the art which fairly fall within the basic teaching herein set forth. Various other embodiments are described below and are classified under (1) user ID registration, (2) ID recognition, (3) group registration and group recognition, (4) selection and provision of information customized to a group, (5) detecting a group at a predetermined spot, (6) grouping method, and (7) others.

(1) User ID Registration

In first to third embodiments, the user ID is registered through the RFID 1A, the mobile terminal 5A, etc. However, instead of the user ID, the ID issued or personal data provided by the user when availing of a service can be registered.

For example, in the information providing system 102 according to the third embodiment shown in FIG. 14, the ID issued to the user and personal data provided by the user when availing of any of the various services can be registered in the externally-provided registration information DBs 43A and 43B. The services include credit card, season pass, ticket, airline ticket, ticket for a play, concert, etc., employee I-card/student I-card, patient's registration card, bank ATM card, point card issued in shops, club membership card, etc.

In all the services mentioned above, either a card or a pass is issued to the user and the user is required to provide at least his/her name to the issuing party at the time the card/pass is issued to them. If the issuing party avails of the registration information DBs 43A and 43B as the databases for managing the IDs of the users, the information registered can be acquired based on the ID of the user.

Even services that do not issue cards such as public utilities (electricity, gas, water, telephone, etc.), Internet service, and Internet-based membership service, manage registration information against predetermined IDs. Using such readily available data obviates the need for registering personal data for providing group-oriented information. In the United States, the social security number, which is assigned to every individual, can be used. By entering a Service Level Agreement (SLA), the information providing system can avail of these IDs for its own purpose.

(2) User ID Recognition

The RFID 1A etc. used in the present invention should preferably acquire ID using radio wave (by non-contact method). Radio waves used have a bandwidths of 13.56 MHz, 2.45 GHz etc. ID can be also acquired by using waves of other frequencies such as infra-red waves, optic waves, ultrasonic waves.

Apart from being in the form of a card, the RFID 1A, ID data can be set in hardware such as a mobile phone, and ID can be verified by biometrics (such as fingerprinting, vein authentication, voice printing, and facial image authentication).

The information providing system 100 can be configured to actively recognize ID from a predetermined distance. Alternatively, to avoid breach of privacy or security, the information providing system 100 can be configured to be able to acquire ID and to make information available to the user only if the user allows his/her ID to be acquired.

Further, the information providing system 100 can be configured to unambiguously recognize the user when the user bearing a near-distance type card like non-contact ID card or contact-type ID card approaches a predetermined location (for instance, a place where a near-distance RFID reader is located) or inserts the card in a card slot.

(3) Group Registration and Group Recognition

Several methods are available for determining whether users form a group based on a human relationship (relationship-based group). One method is, the service provider providing the service of the information providing system 100 defines groups of preset categories. Another method is, the service provider avails of registration information which are already grouped. Yet another method is, the service provider uses the categories created independently by the users.

The user can directly enter another user associated to himself/herself in a predefined category. Alternatively, the relational data 210 can be created from the information entered for acquiring the ID when availing of another service. Entry of information pertaining to members forming a group with a group can be made based on the entry in the “relationship with the user” field filled in by the user in the application forms when availing of services such as discount on mobile phone bill for calls to family members or when specifying a debit account for bill payment for a service.

Even if no information is available by way of direct entry in the “relationship with the user” field, relationship between users can be inferred from common sense or by application of a simple rule. For example, if a person A is a manager of Division X, and a person B is a section chief of the same division in an organization, it can be surmised that A and B share a boss-subordinate relationship, and when the IDs of A and B are recognized, it can be inferred that the two share a boss-subordinate relationship. Similarly, a person S enters information that identifies Y as “family” (S and Y sharing a parent-child relationship). If another person P enters information that identifies S as “sibling”, then it can be surmised that P and Y are “relatives”, and when the IDs of P and S are recognized, they can be inferred as being relatives. These inferences can be given group characteristics, and contents customized to boss-subordinate relationship or relatives can be provided to the users. The inference can be based on one's own rules or on the rules available on the Web by using technologies such as Semantic Web.

Thus, even if the user does not take the trouble to enter relational data, relational data can be obtained from predetermined service providers, group-oriented information can be made available to the users in a group.

The information providing system 102 can be configured to track the locations of all the contacts entered in the address book of the mobile phone of a user and automatically detect whether the persons are hanging out together. Further, the information providing system 102 can be combined with a system that automatically determines, based on conversations between users, whether they are close friends or mere acquaintances.

Even in a parent-child relationship, the contents will be different for different ages. For example, the contents for a 30-year-old parent and a four-year-old child would be different for the contents for a 75-year-old parent and a 48-year-old child. Therefore, the relationship providing system can be configured to make contents available to the users not only based on their relationship but also on their age.

(4) Selection and Provision of Information Customized to a Group

Apart from providing contents associated one-on-one with group characteristics, contents can be categorized according to the genre for each group, and actual contents can be assigned to each category. The contents can be further filtered according to different conditions (location or user preference) before making them available to the user.

If a plurality of contents match the group characteristics, the contents may be ranked according to the degree of match. All the contents matching the group characteristics can be made available or the user can select from a menu a specific genre and contents of the selected genre only can be made available to the user. Ordinarily, the information displaying unit 31 can be made to display general contents, and upon recognition of a predetermined group, group-oriented contents can be displayed in an eye-catching manner (in large fonts, by boxing the contents, by marking with the word “recommended”, etc.)

(5) Detecting a Group at a Predetermined Spot

A plurality of groups may be present at a predetermined location. In such a case, the information displaying unit 31 can display contents by categorizing them in the order in which the groups are recognized, the contents of the group that is recognized first being displayed on top. Alternatively, the screen layout of the information displaying unit 31 can be allotted according to the number of persons in the group. Alternatively, the contents for different groups can be displayed in different colors.

If specific users can be included in a plurality of groups, the group that is applicable to the maximum number of persons in the situation is detected, and contents customized to the detected group is made available to the individuals in the group.

(6) Grouping Method (Based on Past History)

Apart from the personal data registered by the users and the service provider, personal data based on the user's past history can also be registered in the registration information DB 41.

For example, if A, B, and C often visit the places X, Y, and Z, which are all pubs, then A, B, and C can be grouped together as “drinking buddies”. If A, D, and E often go to places S, T, U, V, and W, which are all golf courses, then A, E, and E can be grouped together as “golfing buddies”.

Further, apart from providing information related to golf, information related to sauna, which is likely to be of interest to golfers, can also be provided. Thus, by additionally providing contents of genres related to the group's interest, contents providing can be made very effective.

(7) Others (Services That can be Provided by the Information Providing System)

Companies generally have separate employee cards and guest cards. The information providing system can determine whether a particular group is only of guests or a combination of company employees and guests. Based on this determination, information related to company canteen, guest canteen, way-guidance for the guests, etc. can be provided.

In hospitals, people can be categorized into groups such as doctors, nurses, druggists, patients, relatives of patients, etc. and contents customized to each of the groups. For example, contents related to the same medical case can be provided to the different groups by changing the contents according to the target group. The contents made available to the doctor and nurses may be in such a way as to enable them to decide on the treatment, the contents made available to the doctor and druggist may be related to the drugs suitable for the case, and the contents made available to the patient and his/her relatives may be a layman's description of the medical condition or information related to self-care.

The information providing system 100 can be configured in such a way that a predetermined device provided in a car (such as the RFID reader 11) recognizes the IDs of the travelers, and the display screen of the car navigation device displays the contents customized to the group formed by the owners of the IDs.

The information providing system 100 can be configured in such a way that the RFID reader 11 recognizes the IDs of a group of persons who have entered an elevator, and displays contents customized to recognized groups on a display (the information displaying unit 31) inside the elevator. The information providing system can also be configured to recognize users in a closed space such as a conference room, and provide group-oriented information a large-screen display device in the conference room.

The information providing system can be configured to provide information through car navigation systems of a plurality of cars that are traveling in the same route for a predetermined period. The information in this case can be related to rest spots ahead on the route.

Relevant contents can be made available to users in accordance with the situation in which the users are by providing contents customized to a relationship-based group of a plurality of users hanging out together.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information providing system that provides information to a plurality of users that form a group at a given time, the information being customized to a type of the group, the information providing system comprising:
a transmitting device configured to be carried by each of the users, stores therein user identification data that is unique to a user that carries the user-identification-data storage device, and transmits the user identification data;
a receiving device that receives user identification data from the transmitting devices;
a user-data storage device that stores therein correspondence relation data formed by associating personal data of each of the users with user identification data of each of the users;
a contents storage device that stores therein contents associated with each of a plurality of predetermined group types;
a group determining device that determines an instantaneous group the users have formed at a given time based on a plurality of pieces of user identification data received by the receiving device and the correspondence relation data stored in the user-data storage device, the instantaneous group being one of the predetermined group types;
a contents extracting device that extracts, from the contents storage device, contents matching with the instantaneous group; and
an information providing device that makes extracted contents available to the users that have formed the instantaneous group,
wherein the group determining device determines whether users hanging out together at the given time share a predetermined human relationship, and determines the instantaneous group based on the human relationship.

2. The information providing system according to claim 1, wherein the group determining device is in plurality, and the user-data storage device is connected to the plurality of group determining devices.

3. The information providing system according to claim 1, wherein the group determining device is in plurality, and contents storage device is connected to the plurality of group determining devices.

4. The information providing system according to claim 1, wherein the user-data storage device is in plurality, and the user-data storage device is connected to any one of the group determining device and the user-data storage device connected to the group determining device.

5. The information providing system according to claim 4, further including an ID converting device that transmits personal data from one user-data storage device to another user-data storage device by extracting the personal data based on the correspondence relation between the personal data of the user and the user identification data of the user.

6. The information providing system according to claim 1, wherein the information providing device displays the contents for the user.

7. The information providing system according to claim 1, wherein
the transmitting device is an RFID tag, and
the receiving device is an RFID reader.

8. The information providing system according to claim 1, further including a location-information acquiring device that acquires information about movement of the users carrying the transmitting device,
wherein the group determining device determines, based on the information about movement, whether a plurality of the users that are moving together form the instantaneous group.

9. The information providing system according to claim 8, wherein the location-information acquiring device acquires, from a communication network to which the transmitting device has been connected, the information about movement as well as information about current location of the user.

10. The information providing system according to claim 9, wherein
the communication network includes a plurality of different carrier networks, each carrier network being connected to a corresponding one of the location-information acquiring devices, and
the group determining device connects with the location-information acquiring devices.

11. The information providing system according to claim 8, wherein
the transmitting storage device determines its own location from GPS, and transmits acquired location data indicative of the location to the location-information acquiring device, and
the location-information acquiring device calculates the information about movement based on the location data.

12. A method of providing information to a plurality of users that form a group at a given time, the information being customized to a type of the group, the method comprising:
each of the users transmitting user identification data that is unique to each user by uses of a transmitting device carried by each of the users;
receiving the user identification data by uses of a receiving device;
determining whether users hanging out together at a given time share a predetermined human relationship, based on a plurality of pieces of user identification data received by the receiving device and a correspondence relation data formed by associating personal data of each of the users with user identification data of each of the users, and determines an instantaneous group formed by the usere based on the human relationship;
extracting, from among contents stored associated with a plurality of types of group, the instantaneous group being one of the predetermined group types, contents matching with the instantaneous group; and
providing extracted contents to the users have formed the instantaneous group.
